(19) United States
(12) Patent Application Publication
(10) Pub. No.: US 2006/0239245 A1
(43) Pub. Date: Oct. 26, 2006

(54) Techniques for creating a user-friendly computer-based fax experience

(75) Inventor: Hubert Van Hoof, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/112,843

(22) Filed: Apr. 22, 2005

(51) Int. Cl. H04L 12/66

(52) U.S. Cl. 370/352; 358/400

(57) ABSTRACT

Techniques for creating a user-friendly computer-based fax experience are described. One technique provides a user-interface including a plurality of access points to a fax functionality. The technique also allows a user to select the fax functionality through activation of an individual access point.

### TECHNICAL FIELD

The invention pertains to techniques for creating a user-friendly computer-based fax experience.

### BACKGROUND

Fax use continues to grow worldwide. Similarly, computer use continues to grow worldwide. Often fax users also are computer users or are potential computer users. Despite this overlap between fax use and computer use many fax users continue to utilize non-computer-based faxing. As such, a market exists for an enhanced computer-based fax experience.

### SUMMARY

Techniques for creating a user-friendly computer-based fax experience are described. One technique provides a user-interface including a plurality of access points to a fax functionality. The technique further allows a user of select the fax functionality through activation of an individual access point.

### BRIEF DESCRIPTION OF THE DRAWINGS

FIG. 1 illustrates a user-interface supporting an enhanced fax functionality, in accordance with one embodiment.

FIG. 2 illustrates a system supporting an enhanced fax functionality, in accordance with one embodiment.

FIG. 3 illustrates a system component supporting an enhanced fax functionality, in accordance with one embodiment.

FIGS. 4-11 illustrate screenshots of an enhanced fax functionality, in accordance with one embodiment.

FIG. 12 illustrates a system architecture supporting an enhanced fax functionality, in accordance with one embodiment.

FIG. 13 illustrates exemplary systems, devices, and components in a fax operating environment, in accordance with one embodiment.

FIG. 14 illustrates an exemplary process diagram for creating an enhanced fax experience, in accordance with one embodiment.

### DETAILED DESCRIPTION

Overview

The following description relates to techniques for creating a user-friendly computer-based fax experience.

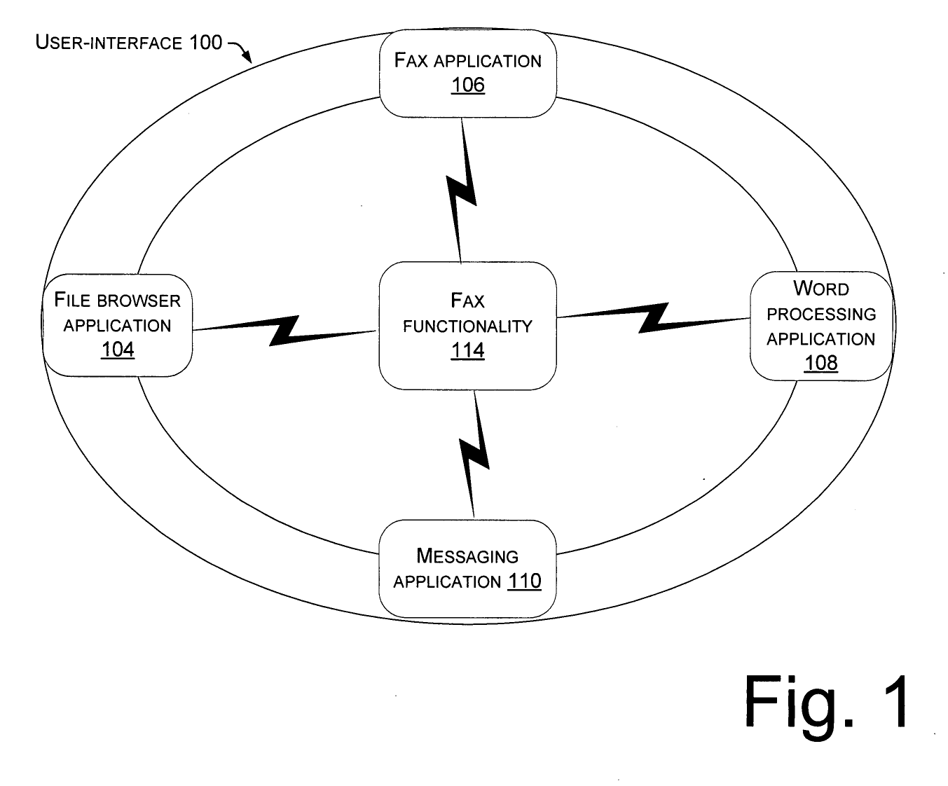

Consider FIG. 1 as an example of a personal computer (PC) user-interface 100 for creating a user's fax experience. Non-limiting examples of applications that can be exposed on user-interface 100 include a file browser application 104, a fax application 106, a word processing application 108, and a messaging application 110. Centrally positioned for purposes of explanation is an integrated fax functionality 114. The fax functionality is achieved, at least in part, by the fax application. For instance, the fax functionality may be achieved by the fax application, in combination with other portions of the user-interface, such as various other applications. Stated another way, the fax functionality may be exposed to a user as a fax client portion of the user-interface.

A user interacting with user-interface 100 and desiring to utilize the fax functionality 114 can access the fax functionality from a number of applications and/or aspects of the user-interface which are convenient for the user. For instance, assume that the user is working in word processing application 108 and composes a document. The user then decides that he or she wants to fax the document to a fax recipient for review. The user can utilize an access point in the word processing application to access the fax functionality 114. In another example, a user may utilize file browser application 104 to locate a particular file. Upon locating the file the user may desire to fax the file to someone. An access point located in the file browser allows the user to access the fax functionality for faxing the file. In another instance, the user may access the fax functionality from an aspect of the user-interface which is not directly related to a specific application. For example, an access point may exist on a portion of the user-interface created by the operating system. For instance, the operating system may allow a user to control a peripheral device coupled to the operating system and may provide an access point to the fax functionality in concert with the user controls for the peripheral device.

Further, in some implementations, the user-interface related to the fax functionality can be consistent with other portions of the user-interface which are available to the user on user-interface 100. For instance, the user-interface may allow the user to launch the fax functionality in the same, or a very similar manner, as is utilized to launch an email functionality. In some implementations the fax functionality may be integrated with another functionality to provide a unified portion of the user-interface. For instance, the fax functionality and the email functionality may be integrated to create an integrated or unified portion of the user-interface relating to communicating information with others whether the communication is via email, fax, or both. For instance, the fax client portion of the user interface may be unified with or have a similar ‘look and feel’ as the email client. Configurations which provide a fax user-interface which is consistent with, and/or integrated with, other portions of the user-interface can be more intuitive to the user and can contribute to improved user satisfaction of both the fax experience and the overall user-interface experience.

Cumulatively, the user-interface configuration described in relation to FIG. 1 allows a user to compose and send a fax in the manner that makes sense to the particular user at any given time. What feels most natural for a particular fax scenario today, may not feel like the best or most effective way for another fax scenario tomorrow. The nature of the content might influence the creation path selected by the user and this implementation allows the user the flexibility to select the path as he or she so desires.

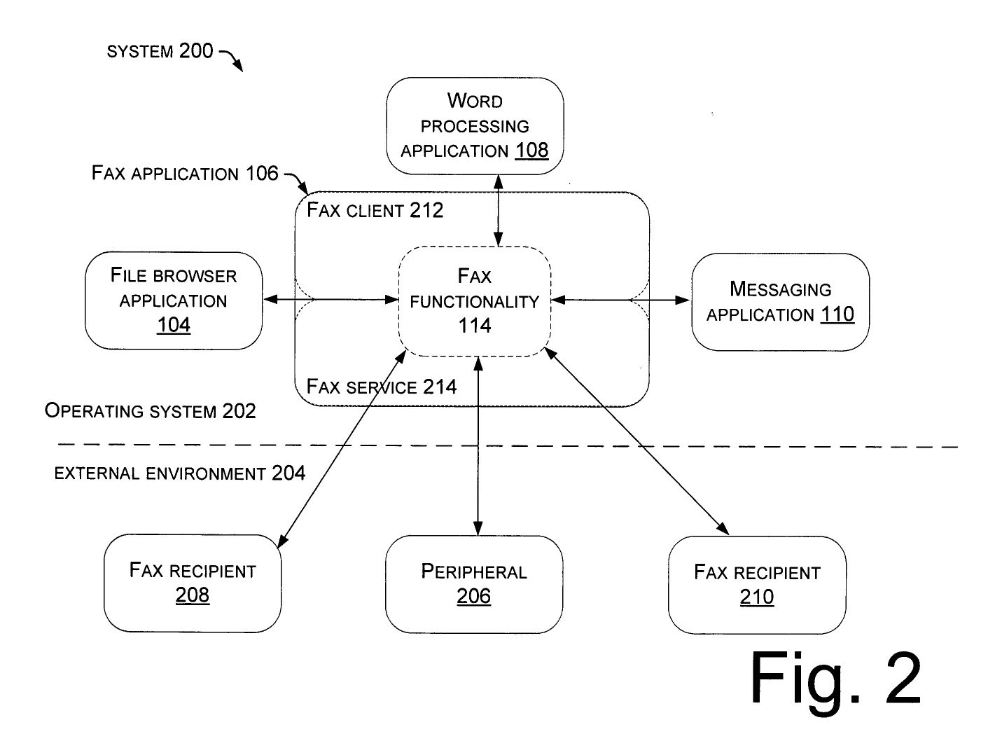

FIG. 2 illustrates an example of a system 200 consistent with providing a flexible and integrated fax functionality to the user-interface. System 200 includes, by means of non-limiting example, file browser application 104, fax application 106, word processing application 108, and messaging application 110 operating in cooperation with an operating system 202. System 200 also includes in an external environment 204, and by means of non-limiting example, a peripheral device 206, and fax recipients 208, 210 communicating with the fax functionality 114 via the operating system 202. In this particular configuration, fax application 106 includes a fax client component 212 and a fax service component 214. In a general sense the fax client 212 relates to the user-interface portions of the fax functionality or how the user interacts with the fax functionality. The fax service component 214 generally relates to the underlying core infrastructure or developer platform of the fax functionality. The fax client component and the fax service component are described in more detail below.

The implementations described above and below are described in the context of a computing environment as commonly encountered at the present point in time. Various examples can be implemented by computer-executable instructions or code means, such as program modules, that are executed by a computer, such as a PC. Generally, program modules include routines, programs, objects, components, data structures and the like that perform particular tasks or implement particular abstract data types.

Various examples may be implemented in computer system configurations other than a PC. For example, various embodiments may be realized in Apple Macintosh computers, tablet PCs, hand-held devices, multi-processor systems, microprocessor-based or programmable consumer electronics, network PCs, minicomputers, mainframe computers, cell phones, and the like. Further, as technology continues to evolve, various implementations may be realized on yet to be identified classes of devices.

Various examples may be practiced in distributed computing environments, where tasks are performed by remote processing devices that are linked through a communications network. In a distributed computing environment, program modules may be located in both local and remote memory storage devices.

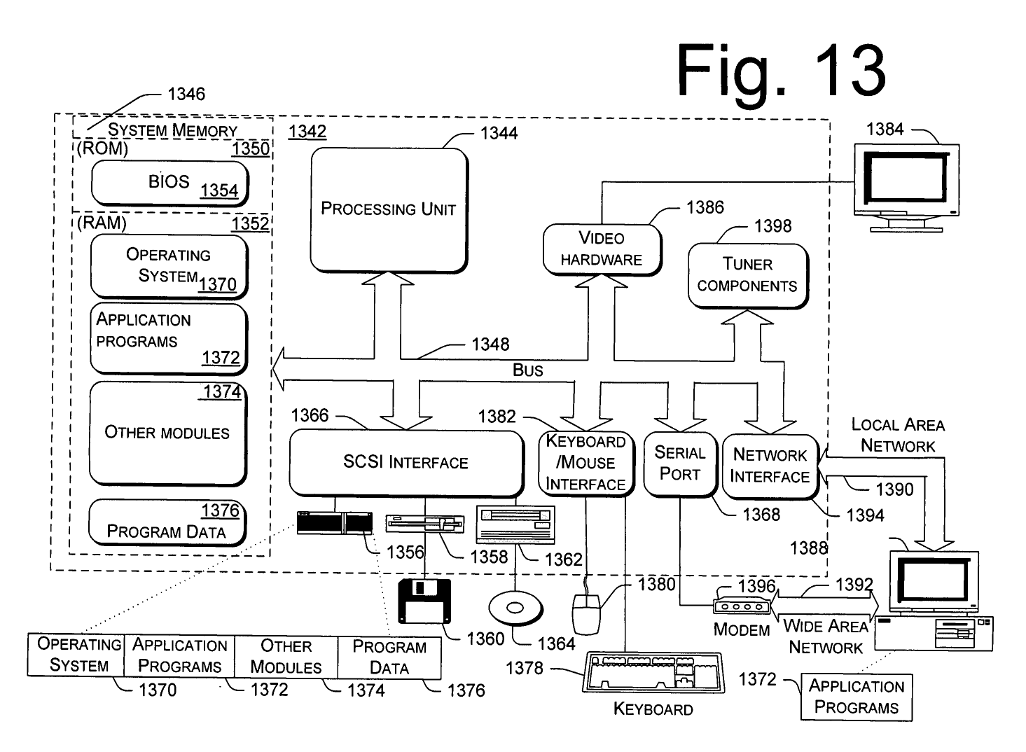

Although the various implementations may be incorporated into many types of operating environments as suggested above, a description of but one exemplary environment appears in FIG. 13 in the context of an exemplary general-purpose computing device and which is described in more detail later in this document under the heading “Exemplary Operating Environment”.

For purposes of explanation and by way of example, more detailed descriptions of various components and functionalities are described below in relation to the Windows® brand operating system offered by Microsoft® Corporation and also in relation to various applications, such as Word® brand word processing application and Outlook® brand messaging application, offered by Microsoft Corporation. The Windows operating system and associated applications are widely recognized and as such provide a suitable platform for explanation. The skilled artisan should recognize other suitable operating systems and/or applications consistent with the discussion provided above and below.

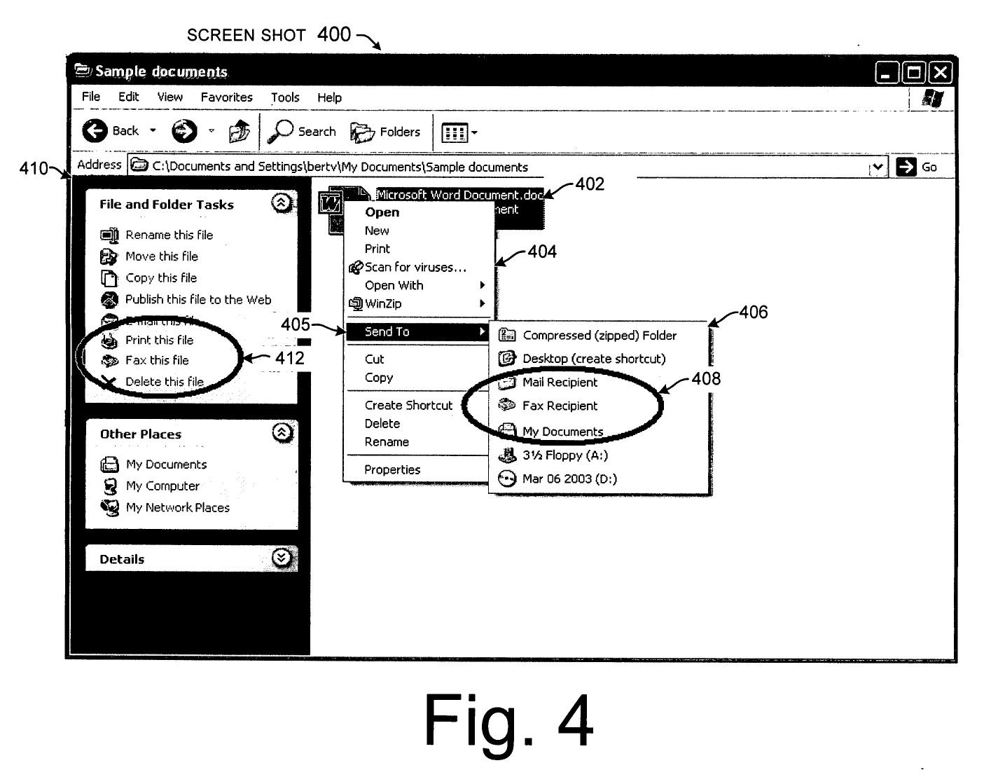

Previous fax solutions, whether hardware-based or software-based, create a fax composition scenario which is serial from beginning to end. In contrast, consider the examples described in relation to FIGS. 4-10 of a user interface providing multiple paths for a user to access a fax functionality and compose a fax. For instance, in addition to the user accessing the fax functionality by accessing a fax application, the user may access the fax functionality through an application and/or portion of the user-interface which is primarily not a fax application or fax-centric functionality. Alternatively or additionally, the implementations described below are easier for the user to learn and use than existing fax solutions.

### Exemplary Embodiments

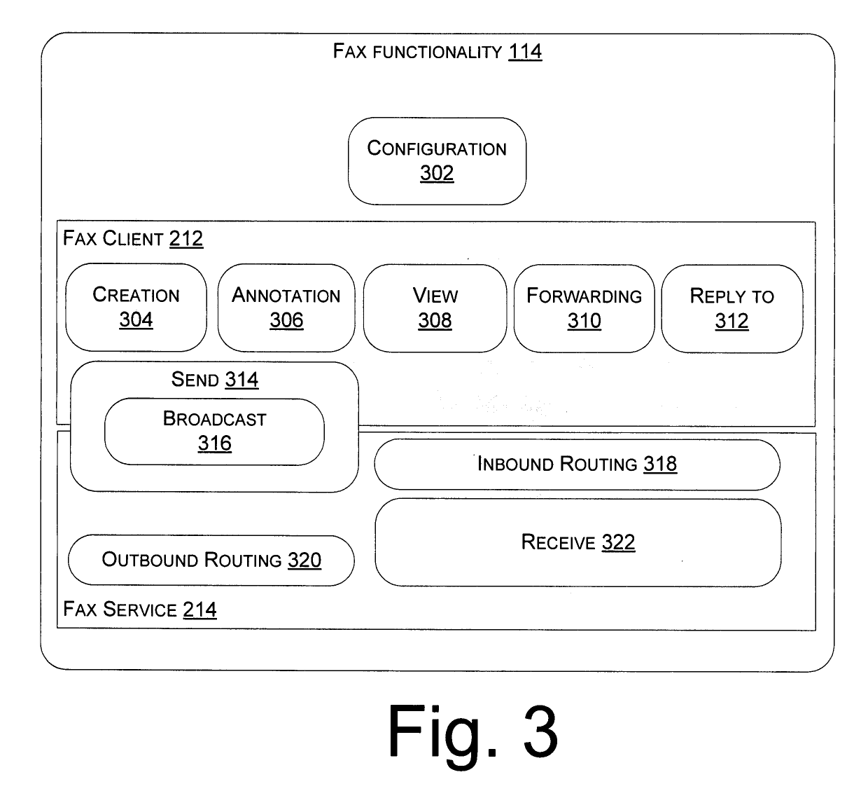

FIG. 3 illustrates a more detailed view of fax functionality 114. The fax functionality includes various functionalities, some of which are represented here as functional blocks. Fax functionality 114 includes a configuration functionality 302, fax client component 212, and fax service component 214. The fax configuration functionality 302 serves to set up individual user fax accounts and configures the fax client and fax service components accordingly.

The fax client 212 generally relates to user-interface portions of the fax functionality. A creation functionality 304, an annotation functionality 306, a view functionality 308, a forwarding functionality 310 and a ‘reply to’ functionality 312 are accomplished by the fax client. The creation functionality allows the user to create or compose a fax. Similarly, the fax can be annotated, viewed, forwarded, and/or replied to by the user. Various fax functionalities will be described in more detail below by way of example.

A send functionality 314 and a sub-set thereof, designated as the broadcast functionality 316, are enabled by acts accomplished by both of the fax client 212 and the fax service 214. The send functionality 314 allows the user to send the fax to a fax recipient. The broadcast functionality 316 allows the user to send the fax to a plurality of fax recipients such that individual fax recipients receive a customized version. In this particular configuration, a portion of the send functionality is accomplished by the fax client 212 and a portion of the send functionality is accomplished by the fax service 214. For instance, the fax client prepares the fax for sending, such as by determining the fax recipients, while the fax service executes sending the fax, such as by sending individual faxes to individual fax recipients.

The fax service 214 accomplishes queuing of faxes and sending them out to a faxing mechanism. As such, an inbound routing functionality 318, an outbound routing functionality 320, and a receive functionality 322 are accomplished by the fax service sub-component 214. In at least some instances, the fax routing functionality is implemented as an API which provides software vendors with a flexible way to connect software applications that route received fax transmissions through multiple routing methods. These routing methods can include, but are not limited to, printing faxes, storing faxes, converting fax graphic images to text files, and delivering faxes in electronic mail attachments.

1. Accessing a Fax Functionality

Several examples for accessing a fax functionality are described below. A user can access a fax functionality utilizing whichever approach seems most appropriate to the user in a particular scenario.

Accessing a Fax Functionality from a File Browser

FIG. 4 illustrates a screenshot 400 encountered utilizing a file browser application, such as a Windows® Explorer® brand file browser application such as may be encountered in relation to Windows XP® brand operating system. In this instance, the user utilizes the browser application to locate a file that the user wishes to fax. Once the file is located, the browser application offers the user several access points to the fax functionality. As a first option, the user can right click on the file's icon 402. Responsive to the user right clicking on the icon, a context menu 404 is generated. The user can select a ‘Send to’ command 405 which causes a second context menu 406 to be generated. From the second context menu the user can select ‘Fax recipient’ as indicated at 408. Alternatively, the user can select from the ‘File and Folder Tasks’ 410 a ‘Fax this File’ command at 412. Responsive to the user command, the fax application is launched. The fax application then generates a fax composition window, examples of which are described in more detail below.

Access a Fax Functionality from a Communication Application

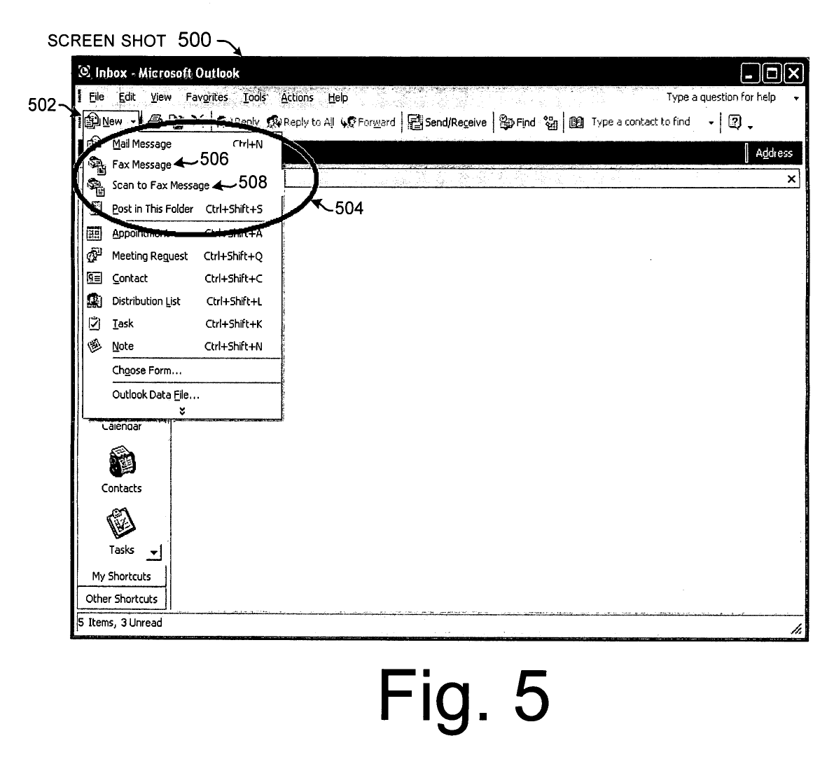

FIG. 5 illustrates a screenshot 500 encountered utilizing an email application such as Windows® Outlook® brand email application. In this particular implementation the fax functionality and email functionality are unified as an overall messaging application. In this instance, a user can access the fax functionality through the unified Outlook-brand messaging application in several ways. For instance, the user may click on the ‘New’ heading/icon indicated at 502. One or more fax options indicated generally at 504 may appear on the list of options provided to the user. In this particular instance, the user may choose from a ‘Fax Message’ 506 or ‘Scan to Fax Message’ 508. Either of these options can allow the user to access the fax functionality through which a fax composition window is generated.

Accessing a Fax Functionality via a Generic Application

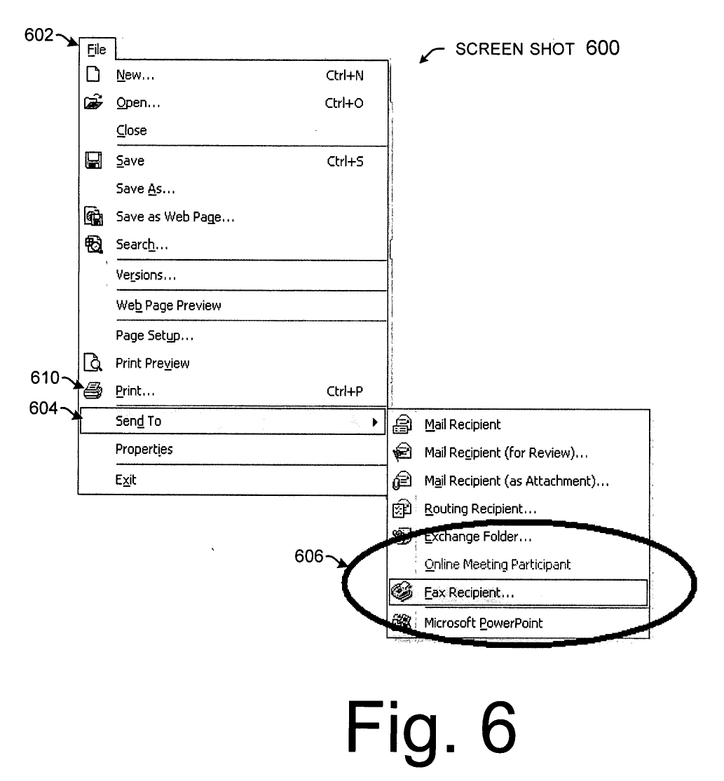

FIG. 6 illustrates another example of an access point to the fax functionality through any of a plurality of different applications which are not specifically fax related and/or which are specifically fax related. Examples of applications which are not specifically fax related may include word processing applications, graphics applications, spreadsheet applications, and a host of other types of applications. In this instance, screenshot 600 allows the user to click on the ‘File’ heading/icon 602. A ‘Send To’ option indicated at 604 is one of the options provided within the ‘File’ heading/icon. One of the possible destinations of the ‘Send To’ option 604 is ‘Fax Recipient’ 606.

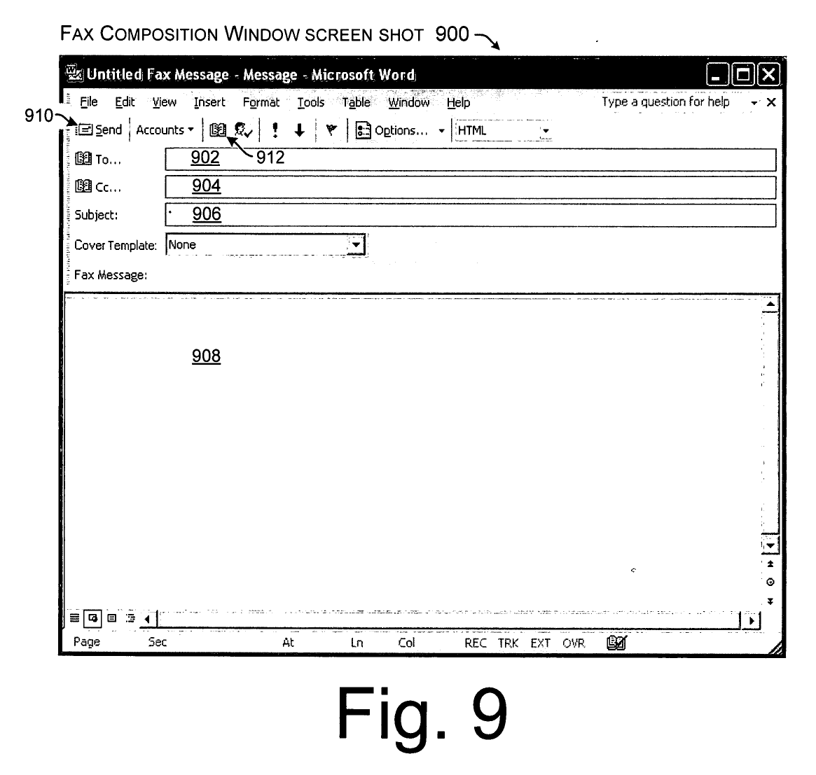

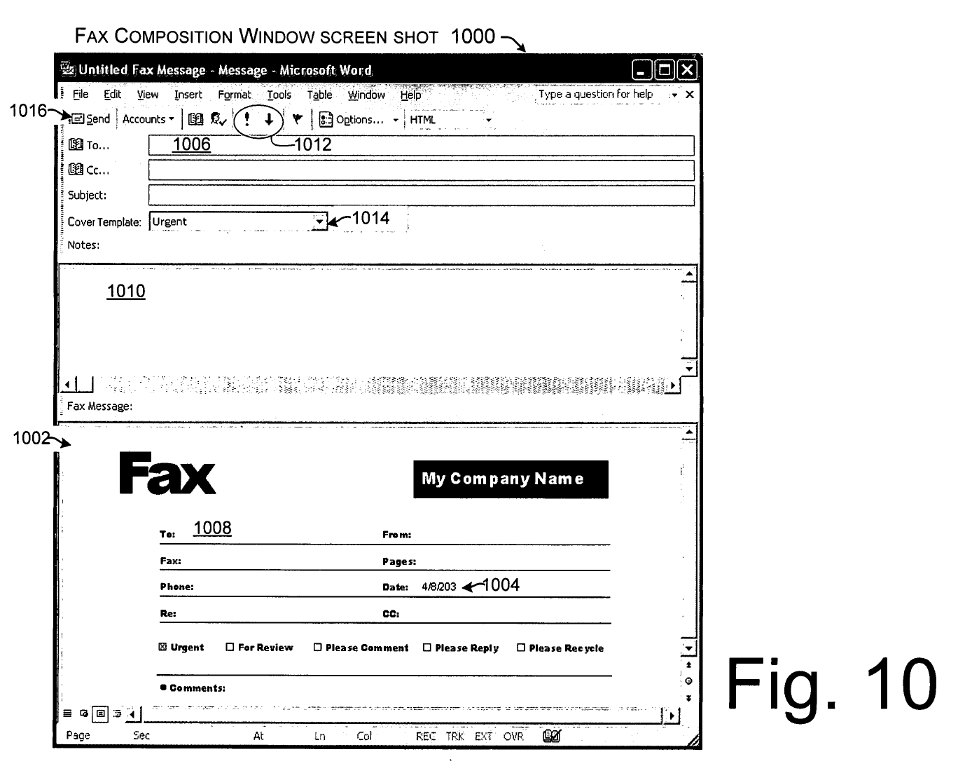

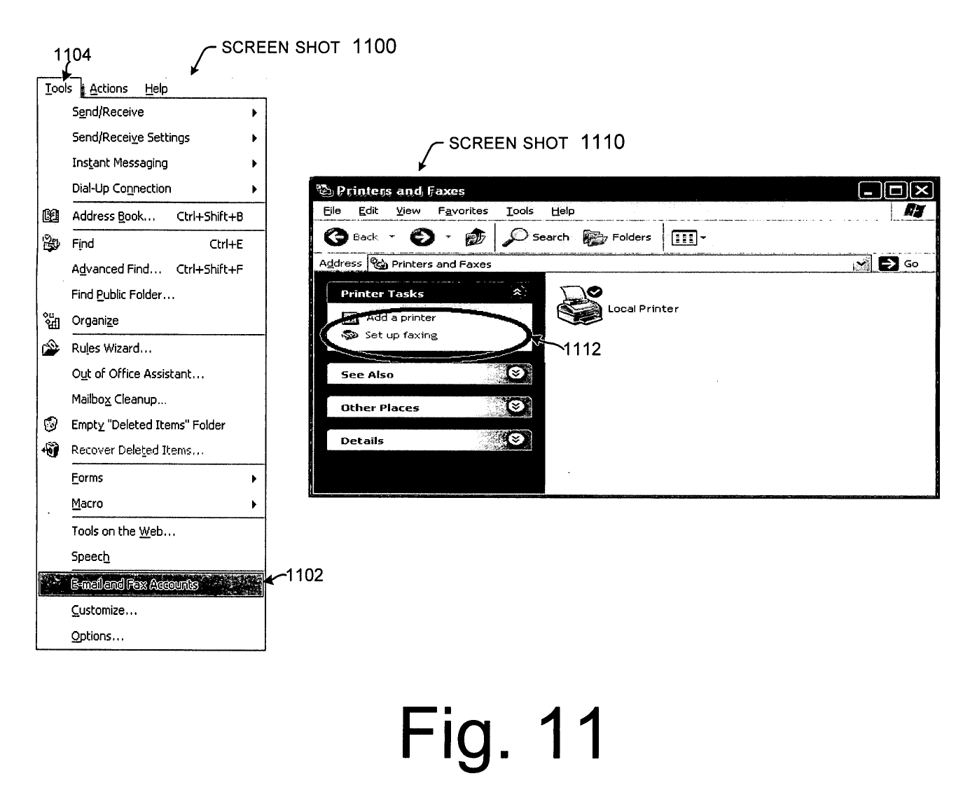

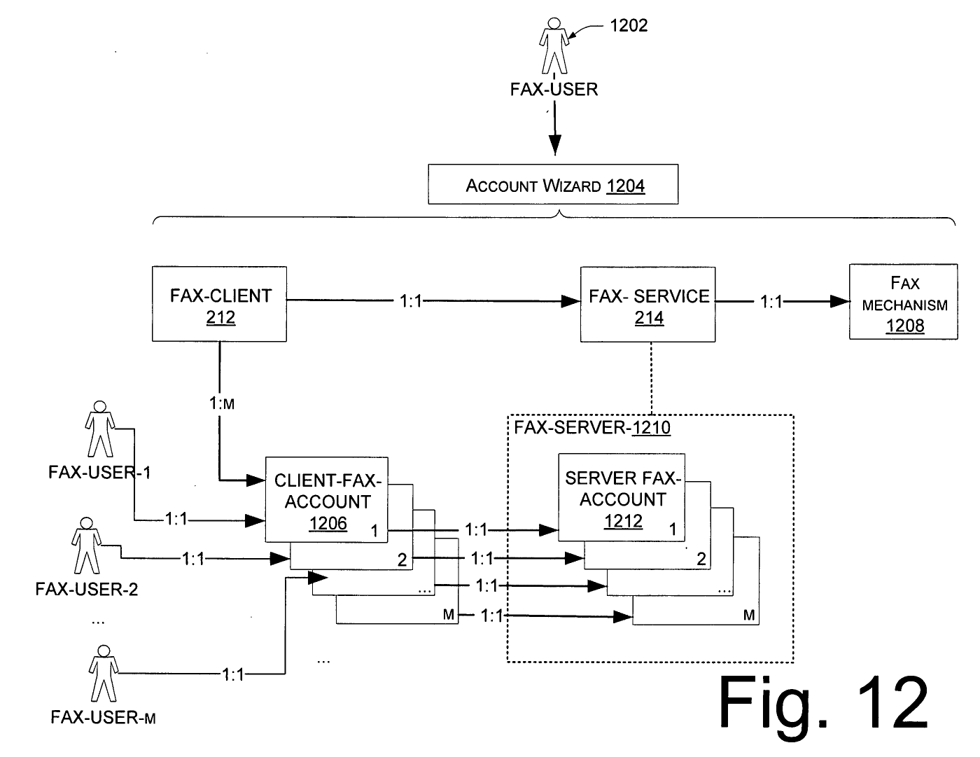

Alternatively or additionally, some configurations provide still another access point to the fax functionality based upon a user selection of a fax printer associated with the user's fax account. Fax account set-up is described in more detail below in relation to FIGS. 11-12. For purposes of explanation, assume that a fax user has composed or located a fax document in a generic application as described above in relation to FIG. 6. The user can select a print command as illustrated generally at 610. A print window is generated responsive to the print command. The print window allows the user to access the fax functionality by selecting the associated fax printer from the print window. Selection of the fax printer generates a fax composition window and the fax printer's print driver renders the user's file into the fax composition window as a bit map image. Alternatively the fax document may be attached to the fax composition window. The fax composition window and associated details are described below in relation to FIGS. 9-10.

Accessing a Fax Functionality via a Fax Application

In some implementations, the fax application may be a fax-dedicated application which the user can access in any of a multitude of known ways. Alternatively or additionally, the fax application may be integrated with other applications to create a more unified user-interface. In an instance where the user prefers to access the fax functionality more directly, the user may simply open the fax application. Within the fax application, the user may proceed along various paths. For instance, the user may select ‘New fax’. Responsive to the user command, the fax application generates a fax composition window, examples of which are described below in relation to FIGS. 9-10.

Create a Fax from an Existing Paper Document

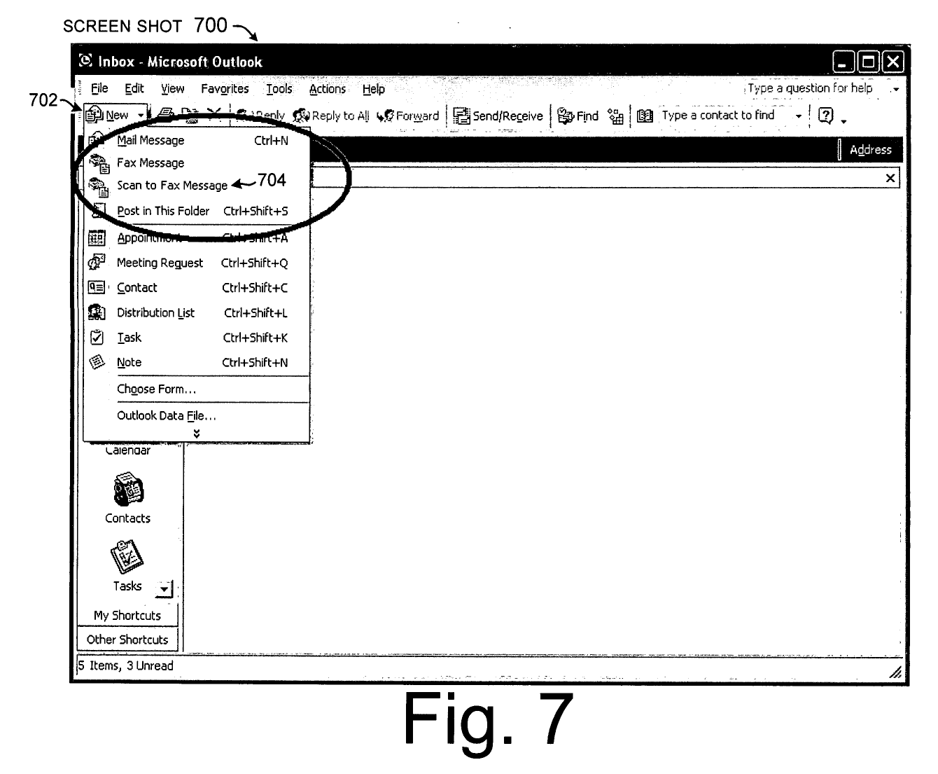

If the user wants to send an existing paper document via fax he/she can follow the path that seems most straightforward. For instance, the user can open the fax application, and with a single click, scan to the fax application. For example, FIG. 7 shows a screenshot 700 of such a configuration where the fax functionality is integrated with the email functionality as a unified Windows Outlook-brand messaging or communication application. In this instance the user can click on the ‘New’ heading/icon 702 and scroll down to ‘Scan to Fax Message’ 704 to import directly from the scanner to the fax application. In at least some applications, in relation to a scanner or multi-function peripheral (MFP) a driver will cause the scan to start automatically and scan any paper document on the scanner or MFP without further user intervention. In instances where the scanner does not have a document feeder, the user subsequently may be asked if the user wants to scan another page. Also, in scenarios where more than one scanner is attached to the PC the user will be asked which device to use or scan from.

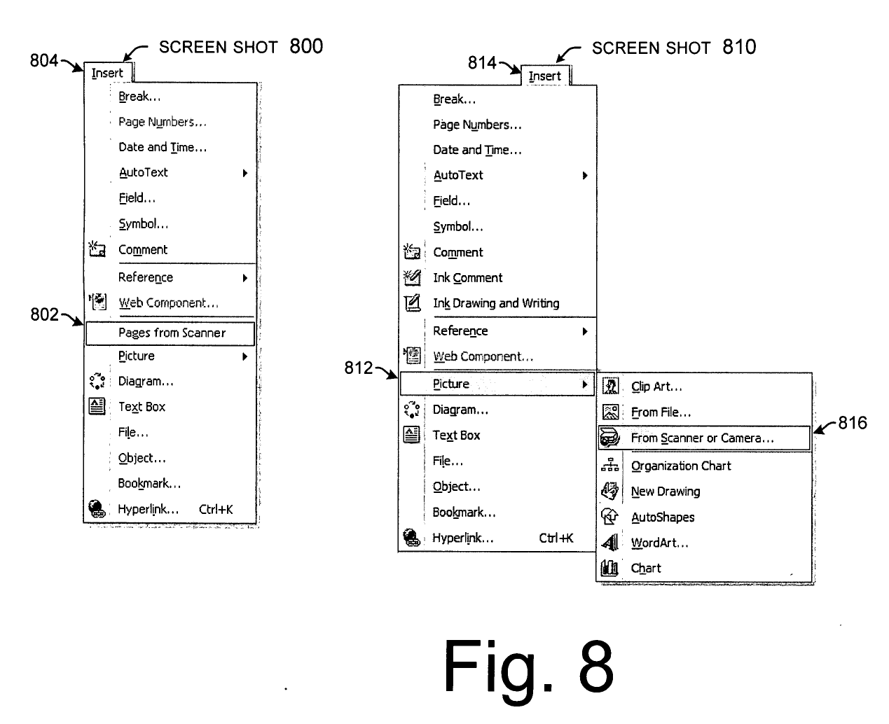

FIG. 8 illustrates two alternative configurations for transferring content from a scanner to a fax application and inserting the content into a fax message that is being composed. As shown in screenshot 800, the user can open the fax application, and select ‘Pages from Scanner’ 802 under the ‘Insert’ menu 804 and insert scanned pages directly into the body of the compose window. This scan does not require any further user intervention in a scenario where the desired pages are already positioned on the scanner. Once the pages are scanned into the fax application's composition window, the user can edit between the scanned pages and/or move the scanned pages as described above and below.

Still a further option which is shown in screenshot 810 is for the user to open the fax application, and select ‘Picture’ 812 under the ‘Insert’ heading/icon 814. The user can then select ‘From Scanner or camera’ 816 to insert a scanned area of a single page directly into the body of the fax compose window. In some such instances, the user can utilize software associated with the scanner that allows the user to crop the image and manipulate other scanning parameters as desired.

Several examples are provided above which allow a user to access a fax functionality in a manner which seems convenient to the user. What feels most natural for a particular fax scenario today, may not feel like the best or most effective way for another fax scenario tomorrow. For instance, the nature of the content might influence the creation path selected by the user and these implementations allow the user the flexibility to select the path as he or she so desires.

The examples provided above are not intended to be limiting in any manner. To the contrary, these examples should aid the skilled artisan in applying the concepts described above and below to new system configurations as they become available so that a user-interface can be configured which collectively provides increased fax flexibility to the user.

As evidence by the above examples, the user can activate the fax functionality through any of the diverse access points. Responsive to the user access, a fax composition window can be generated for the user. At least some implementations generate fax composition windows that have a consistent configuration regardless of the user-selected access point. Such configurations tend to produce an enhanced user experience by generating consistent user interface configurations which are familiar to the user. Several examples of composition windows generated responsive to user access are described below.

2. Composing a Fax

FIG. 9 illustrates a screenshot of one implementation of a fax composition window 900. The fax composition window 900 can include various fields and allow various user commands, only some of which are mentioned here with specificity. In the particular configuration illustrated in FIG. 9, the fax composition window has a “To” field 902, a “Cc” field 904, a “Subject” field 906 and a compose field 908. Further, this configuration includes various command tools including “Send” 910, and an address book icon 912, among others. The address book can be a single address book shared with an email client or a dedicated address book for the fax application.

One or more fax recipients can be entered into the ‘To’ and ‘Cc’ fields 902, 904 by any combination of manually typing and/or selecting the fax recipients from a contacts or address book 912. In some implementations when the user selects a fax recipient from the contacts or address book, the fax recipient appears in the appropriate ‘To’ or ‘Cc’ field as “recipient name@fax number”. Such a configuration is consistent with the familiar format of many email applications which utilize a “recipient name@address” format. Such a configuration also facilitates enabling a search tool for sent and/or received faxes.

Situations in which the user designates multiple fax recipients for a single fax composition may be referred to as a broadcast fax. At least some implementations customize individual faxes which are sent to the individual fax recipients in a broadcast fax scenario. For more detail regarding broadcast faxing, the reader is referred to U.S. patent application Ser. No. ______, entitled “Techniques for Composing and Sending a Broadcast Fax”, naming as inventor Hubert Van Hoof, filed on ______, assigned to the assignee of this document, and bearing attorney docket number ms1-2498us.

In at least some configurations, the user can send a fax with a reduced number of serial steps for the user to follow in order to send the fax. For instance, the user designates at least one fax recipient and includes some kind of content in the fax composition window before sending the fax. The user is allowed to choose a relative order of other steps involved in sending the fax and even whether some of the steps are appropriate for a given fax. For instance, the user may enter content in the compose field 908, then select a fax recipient for the ‘To’ field 902 and then subsequently add a subject line to the ‘Subject’ field 906 before clicking ‘Send’ 910.

In another instance, the user may add the fax recipient to the ‘To’ field 902 and then complete the ‘Subject’ field 906 before adding content to the compose field 908. While the illustrated fax composition window configuration provides many versatile features it can also provide a computer-based fax experience which allows the user to send a fax with very few steps. For instance, in a scenario where the fax composition window is pre-populated with content, the user may simply designate a fax recipient for the ‘To’ field 902 and click ‘Send’ 910. Such a configuration can lead to enhanced user satisfaction when compared to previous computer-based fax solutions which require more steps be completed by the user.

The fax composition window allows the user to include content in the fax by any combination of composing within the fax compose field 908, pasting, attaching, inserting, and/or dragging-and-dropping content into the fax composition window. Alternatively or additionally, and as described in the examples above, the fax composition window may be automatically pre-populated with content from other applications or sources such as scanning devices.

At least some implementations allow the user to insert new or additional content in-between pages of content of the fax. For instance, a user may scan several pages of content into the fax composition window. The user can then add content, such as comments, between the scanned pages while maintaining the integrity of the individual scanned pages. Alternatively or additionally the user can rearrange the scanned pages while maintaining the integrity of the individual pages. Stated another way, the content of an individual scanned page can be maintained while allowing the user to change the relative order of the pages and/or to add content between the pages.

The illustrated fax composition window 900 has a ‘look and feel’ consistent with the existing Windows Outlook-brand email user-interface with which many computer users are already comfortable. Similarly, the fax composition window and/or other aspects of the fax functionality can be configured to be consistent with the ‘look and feel’ of other applications including other email applications. Such configurations can create an enhanced user experience as the fax user-interface intuitively follows a known format.

FIG. 10 illustrates a screenshot 1000 of another fax composition window configuration. In this particular configuration, a fax coversheet 1002 is generated for the user as a component of the fax composition window 1000. In various implementations, the fax coversheet can be generated automatically or in response to a user command. The fax coversheet can be automatically populated by the fax application. For instance the ‘Date’ field 1004 can be automatically completed by the fax application. Further, in another instance, if the user enters a fax recipient in the ‘To’ field 1006, then the fax application can automatically populate the ‘To’ field 1008 of the fax coversheet. This particular configuration also allows a user to add content to the notes field 1010. Any content from the notes field is automatically incorporated onto the fax coversheet 1002. This implementation further allows the user to specify a relative urgency of the fax document. In the illustrated configuration the user can designate the relative urgency from icons 1012 or from a dropdown list 1014. The specified urgency is automatically populated to the coversheet.

When a coversheet 1002 is utilized, any other content, whether composed within the fax composition window or inserted, is automatically positioned after the coversheet. A ‘fax view’ functionality can allow the user to preview the fax document as it will be sent. The user can also specify the type of fax receipt or confirmation. For instance, the user may desire to receive an email confirmation in a designated email account, i.e. the user's email account. The user may be able to select from other options such as an Instant Messaging (IM) message, or no Delivery Receipt.

3. Sending a Fax

At some point in the composition process the user reaches a point where he or she desires to send the fax. Various user command options can be provided to allow the user to fax the content. For instance, after a message has been composed, the user clicks “Send” 1016. In some implementations, the send command causes the fax message to move from a “Drafts” folder to “Outbox” folder, whereupon it waits until “Send/Receive” is clicked, or an auto send/receive function activates. Once the fax message is sent completely without errors the message will move to a Sent Items folder.

The concepts described above and below enable fax functionality that is otherwise unavailable to the user. For instance, in some configurations, such as tablet PCs, a user can receive a fax document, or scan in a document and then sign the document to create a digitized signature on the document. The user can then fax the document by designating a fax recipient and clicking send, as described above.

4. Receiving a Fax

In some implementations, incoming faxes are delivered to a client inbox. The client inbox may be a dedicated fax client inbox or a shared or unified messaging inbox. Multi-page faxes may take an extended period of time to deliver. As such, some configurations may receive the entire fax before delivery to the inbox. Other configurations can make the fax available to the user page-by-page as the fax arrives. For instance, an icon of a fax sitting in the inbox may be utilized to indicate that the fax has not been completely received yet. In one such scenario, a fax message in the inbox is indicated in one of three possible states which may be represented with text and/or with distinguishable icons. A first condition indicates the fax is being received. A second condition indicates that the fax has been received in its entirety. A third or failed condition indicates that the fax was not completely received before an error occurred. In the case of an error, some implementations may allow the user to view any pages which were received prior to the failure.

5. Viewing a Fax

In some implementations, faxes received in the inbox can be viewed by the user in several ways. For instance, in some implementations, viewing a fax can be similar to viewing an email, and as such does not require a new skill-set for most computer users. For instance, the user may view a fax by double-clicking a line item in the inbox representing the received fax message. In another scenario, a fax reader pane may be utilized. In some configurations the fax reader pane has two main panes. Some of these configurations include scroll bars for instances when there is more data than fits the pane's size: For example, some configuration may have a thumbnail pane on the left side of the window and a reader pane on the right side of the window. The user may select a page thumbnail by mouse-clicking in the thumbnail pane to get a full view of the fax page in the reader pane of the window. The user clicks on subsequent pages as desired. Alternatively, the user may open the fax by single clicking the line item in the inbox and then selecting “Open” in the File menu. Further still, the user may navigate through the pages by using the scroll bars on the right hand side of the reader pane.

In many of these configurations, the user views a fax utilizing commands which may already be familiar in an email scenario. Such a configuration can seem more intuitive to the user and result in an enhanced user experience.

Further, in the configurations described above, faxes are a distinct message type which can be viewed directly by the user. Such a configuration can be more intuitive to the user than configurations which attach a fax to another message type. For instance other configurations may require a user to first access an instance of the first message type, such as an email and then open the fax which is attached to the email.

6. Replying to a Fax

Some implementations allow the user to reply to the fax sender. The fax functionality automatically can capture the original sender's telephone number such as through Transmitting Subscriber Identification (TSID) information, and/or by utilizing a smart combination of optical character recognition (OCR) and/or handwriting recognition on the fax coversheet. In an event that the sender's phone number cannot be determined, the reply functionality can be disabled.

If the “Reply” function is available, invoking the command will create a new fax compose window. A fax option functionality allows the user to designate whether the original fax message is included in the reply message or not. When it is included, the entire message can be in-lined in the message body, or included as an attachment.

7. Forwarding a Fax

In some implementations, forwarding a received fax message invokes a new fax composition window in which the original fax message is in-lined within the message body. The fax composition window is then treated as described above for composing a new fax.

Alternatively or additionally to forwarding the fax to a fax recipient, the fax may also be forwarded to an email recipient. In a scenario where the user chooses to forward the fax to an email recipient a new e-mail composition window is invoked. The original fax message is added to the email as a file attachment. The file attachment can be in any suitable format such as TIFF or PDF. The attached fax can be named a descriptive name such as “Fax Message from <Sender ID>-<Subject>”. The use of a descriptive and/or unique name creates a more searchable fax history should the user desire to search for the fax message.

8. Fax Set-Up

In some implementations, fax set-up involves setting up a fax client and fax service for a user. In some implementations, fax accounts can be set up in a similar way as e-mail accounts-are set up. Fax account set-up can be invoked in a number of ways. For instance, as evidenced at screenshot 1100 of FIG. 11, the user can select the ‘E-mail and Fax Accounts’ 1102 menu item under the ‘Tools’ menu 1104 of the unified messaging client. Another option is for the user to set up a fax account via a printers and faxes option, an example of which is evidenced at screenshot 1110. The user can select ‘Set up faxing’ as designated at 1112 which among other solutions can launch a fax set-up wizard. Some implementations automatically create a fax printer for every fax account. The fax printer can be utilized to access the fax functionality as described above. Further, the fax printer's print driver can be utilize for converting user selected content into bit map images which can be automatically imported into a fax composition window generated for the user.

FIG. 12 illustrates an example of a system level configuration for setting up a fax user 1202. The fax set-up can be accomplished with a set-up tool such as an account wizard 1204. The fax account set-up covers setting up the fax client 212 and the fax service 214. The fax client acquires user specific information from a client fax account 1206 set-up for an individual fax user. Client fax account 1206 is an account created on the client machine that describes the particular fax connection and that details the settings used with that connection.

Setting-up the fax service 214 includes establishing communications with a fax mechanism 1208 for delivering or receiving a fax. Examples of fax mechanisms include the PC's local fax modem, a fax modem built in to a connected multi-function peripheral (MFP) device, a Windows fax server, a Microsoft® Exchange® Server, or a Fax Service Provider (FSP) among others. In an event that multiple fax mechanisms are available a user may be requested to designate a specific fax mechanism for a particular fax operation.

Fax client 212 and fax service 214 can communicate with a fax server 1210. A server fax account 1212 is created on fax server 1210 for individual fax users for their respective accounts. The system architecture described above can be expanded to function in server configurations as should be recognized by the skilled artisan. For additional information on fax accounts and fax account set-up, the reader is referred to U.S. patent application Ser. No. ______, entitled “Fax Accounts and Re-Assigning Fax Messages”, naming as inventor Hubert Van Hoof, filed on ______, assigned to the assignee of this document, and bearing attorney docket number ms1-2509us, and U.S. patent application Ser. No. ______, entitled “Fax Accounts”, naming as inventors Hubert Van Hoof, Manoj Jain, and Raghavendra R, filed on ______, assigned to the assignee of this document, and bearing attorney docket number ms1-2510us.

For ease of explanation, the above examples are primarily described in relation to fax features of the user-interface. Some implementations maintain the fax functionality as a separate and distinct portion of the user-interface. Other implementations unify the fax features with other message types to create a unified messaging user-interface. For instance, some implementations may organize the email and fax interfaces within a messaging user-interface but otherwise separate the two message types. For example, at a particular instance the user either selects a fax functionality or an email functionality. Other configuration may unify the message types to a further extent. For instance, in some configurations, a user can compose a message and select both fax recipients and email recipients for the message. Similarly, the user may receive a fax and forward the fax to another fax recipient and an email recipient. Similarly, the user may receive an email and forward the email to a fax recipient. The skilled artisan should recognize other implementations consistent with the concepts described above and below.

Exemplary Operating Environment

FIG. 13 shows an exemplary computing device that can be used to implement the software-based fax experience described above. Computing device 1342 comprises one or more processors or processing units 1344, a system memory 1346, and a bus 1348 that couples various system components including the system memory 1346 to processors 1344. Threading techniques can be employed on the one or more processors to allow parallel processing of multiple tasks by multiple processing threads.

The bus 1348 represents one or more of any of several types of bus structures, including a memory bus or memory controller, a peripheral bus, an accelerated graphics port, and a processor or local bus using any of a variety of bus architectures. The system memory 1346 comprises read only memory (ROM) 1350 and random access memory (RAM) 1352. A basic input/output system (BIOS) 1354, containing the basic routines that help to transfer information between elements within computing device 1342, such as during start-up, is stored in ROM 1350.

Computing device 1342 can further comprise a hard disk drive 1356 for reading from and writing to a hard disk (not shown), a magnetic disk drive 1358 for reading from and writing to a removable magnetic disk 1360, and an optical disk drive 1362 for reading from or writing to a removable optical disk 1364 such as a CD ROM or other optical media. The hard disk drive 1356, magnetic disk drive 1358, and optical disk drive 1362 are connected to the bus 1348 by an SCSI interface 1366 or some other appropriate interface. The drives and their associated computer-readable media provide nonvolatile storage of computer-readable instructions, data structures, program modules, and other data for computer 1342. Although the exemplary environment described herein employs a hard disk, a removable magnetic disk 1360 and a removable optical disk 1364, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 1356, magnetic disk 1360, optical disk 1364, ROM 1350, or RAM 1352, including an operating system 1370, one or more application programs 1372 (such as a user agent or browser), other program modules 1374, and program data 1376. A user may enter commands and information into computer 1342 through input devices such as a keyboard 1378 and a pointing device 1380. Other input devices (not shown) may comprise a microphone, joystick, game pad, satellite dish, scanner, or the like. These and other input devices are connected to the processing unit 1344 through an interface 1382 that is coupled to the bus 1348. A monitor 1384 or other type of display device is also connected to the bus 1348 via an interface, such as video hardware 1386. In addition to the monitor, personal computers typically comprise other peripheral output devices (not shown) such as speakers and printers.

Computer 1342 commonly operates in a networked environment using logical connections to one or more remote computers, such as a remote computer 1388. The remote computer 1388 may be another personal computer, a server, a router, a network PC, a peer device or other common network node, and typically comprises many or all of the elements described above relative to computer 1342. The logical connections depicted in FIG. 13 comprise a local area network (LAN) 1390 and a wide area network (WAN) 1392. Such networking environments are commonplace in offices, enterprise-wide computer networks, intranets, and the Internet.

When used in a LAN networking environment, computer 1342 is connected to the local network through a network interface or adapter 1394. When used in a WAN networking environment, computer 1342 typically comprises a modem 1396 or other means for establishing communications over the wide area network 1392, such as the Internet. The modem 1396, which may be internal or external, is connected to the bus 1348 via a serial port interface 1368. In a networked environment, program modules depicted relative to the personal computer 1342, or portions thereof, may be stored in the remote memory storage device. It will be appreciated that the network connections shown are exemplary and other means of establishing a communications link between the computers may be used.

The computer could also contain analog or digital tuner components 1398. The tuner components can be linked to the system either through an internal or extended bus such as PCI or external bus such as USB bus, IEEE-1394 bus. The tuner components allow the system to receive broadcasting TV through standard TV broadcasting media such as terrestrial, cable, and satellite.

Generally, the data processors of computer 1342 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The system described herein comprises these and other various types of computer-readable storage media when such media contain instructions or programs for implementing the blocks described, in conjunction with a microprocessor or other data processor. The system described can also comprise the computer itself when programmed according to the methods and techniques described herein.

For purposes of illustration, programs and other executable program components such as the operating system are illustrated herein as discrete blocks, although it is recognized that such programs and components reside at various times in different storage components of the computer, and are executed by the data processor(s) of the computer.

Exemplary Processes

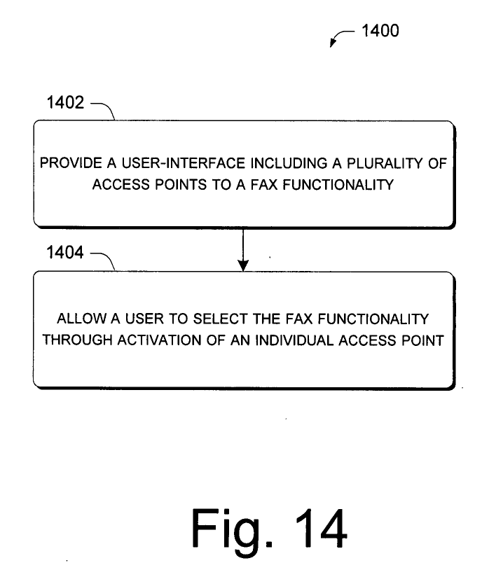

FIG. 14 represents a process for creating a user-friendly computer-based fax experience in accordance with one embodiment.

Block 1402 provides a user-interface including a plurality of access points to a fax functionality. For example, access points may be included through word processing and spreadsheet applications, among others. Alternatively or additionally, access points may be provided in relation to peripheral devices functionally coupled to the computer. For instance, the user-interface may allow the user to control peripheral devices, such as scanners and MFPs. One or more access points may be provided in relation to the user controls for the peripheral device(s).

Block 1404 allows a user to select the fax functionality through activation of an individual access point. In at least some implementations, the user can select a convenient access point which serves to launch the fax application. The fax application generates a fax client and causes a fax message, such as a fax composition window, to be opened in the fax client. To enhance the user experience, the fax client may be unified with other messaging functionalities in a unified messaging client. Alternatively, the fax client may be configured to have a similar ‘look and feel’ as other portions of the user interface. For instance, the fax client may have a ‘look and feel’ reminiscent of the email client.

Further, depending upon the individual access point utilized by the user, the fax message may be pre-populated with content associated with the access point. At least some implementations allow the user to send the fax with a reduced number of user actions. For instance, in some implementations, the user simply designates one or more fax recipients from an integrated contacts or address book and/or types one or more fax recipient phone numbers and clicks send. A selection of a cover page is optional and permits the user to add additional content. A user can add any number of files in any order, either as attachments, or as in-line images, or simply add content by typing in the fax body. These techniques provide ease of use combined with extreme flexibility and hence a more satisfying user experience than existing computer-based fax configurations.

Conclusion

The described embodiments allow a user to access a fax functionality through any one of a plurality of fax access points of the user-interface. At least some of the fax access points are associated with applications which are not primarily fax applications. Some embodiments further provide a user-interface which includes a fax functionality portion with a ‘look and feel’ which is consistent with and/or unified with the look and feel of another non-fax application. Various examples which can contribute to such a unified ‘look and feel’ are described above in relation to the Windows Outlook brand email/messaging product for use on the Windows brand operating system. Other configurations may generate a similar ‘look and feel’ as various other applications, such as various other email applications for use on the Windows brand operating system and/or other operating systems such as Linux, and Mac OS, among others.

Although embodiments relating to techniques for creating a user-friendly computer-based fax experience have been described in language specific to structural features and/or methods, it is to be understood that the subject of the appended claims is not necessarily limited to the specific features or methods described. Rather, the specific features and methods are disclosed as exemplary implementations for creating a user-friendly computer-based fax experience.

1. One or more computer-readable media having computer-readable instructions which, when executed, implement a method comprising:
providing an access point to a fax functionality in at least one application that is not primarily a fax application; and, permitting a user to fax data from said at least one application via the fax functionality.

2. The computer readable media as recited in claim 1, wherein the act of permitting presents a fax composition window for the user which is pre-populated with the data from said at least one application.

3. The computer readable media as recited in claim 1, wherein the act of permitting presents a fax composition window for the user through which a user can perform one or more of the following: attaching content to the fax composition window, pasting content into the fax composition window, typing content into the fax composition window; and inserting data into the fax composition window.

4. The computer readable media as recited in claim 1, wherein the act of permitting enables the user to fax the data by completing as few as two additional acts.

5. The computer readable media as recited in claim 4, wherein the two additional acts comprise an act of designating a fax recipient and an act of entering a send command.

6. A method comprising:
providing a user-interface including a plurality of access points to a fax functionality; and, allowing a user to select the fax functionality through activation of an individual access point.

7. The method as recited in claim 6, wherein the act of allowing comprises launching a fax application configured to generate a fax composition window pre-populated with data from the access point.

8. The method as recited in claim 6, wherein the act of allowing comprises launching a unified fax and email application having a shared address book from which a user can select both fax recipients and email recipients.

9. The method as recited in claim 6, wherein the act of providing comprises providing at least some of the access points in applications which are not primarily fax applications.

10. The method as recited in claim 6, wherein the fax functionality allows the user to send a fax by performing as few as two additional acts.

11. The method as recited in claim 10, wherein the additional acts comprise designating a fax recipient and entering a send command.

12. The method as recited in claim 6, wherein the fax functionality is achieved, at least in part, by a fax application which is integrated with an email application to create a unified fax and email functionality.

13. A method as recited in claim 12, wherein the unified fax and email functionality is configured to generate a single composition window in which the user can select a fax recipient, an email recipient, or both a fax recipient and an email recipient.

14. The method as recited in claim 6, wherein the fax functionality includes a fax composition window and wherein a user can perform one or more of: attaching content to the fax composition window, pasting content into the fax composition window, typing content into the fax composition window, and designating a fax recipient relative to the fax composition window.

15. A system, comprising:
user-interface means having a plurality of user access points at least some of which are primarily non-fax related but through which a user can fax data; and, means for enabling a user to fax data via the access points.

16. The system as recited in claim 15, wherein the means for enabling comprises a unified email and fax application.

17. The system as recited in claim 15, wherein the means for enabling comprises a fax application configured to be integrated with an email application to create a unified user-interface component.

18. The system as recited in claim 15, wherein the means for enabling further allows the user to email the data.

19. The system as recited in claim 15, wherein the means for enabling pre-populates a fax document with the data.

20. The system as recited in claim 15, wherein the means for enabling does not impose a predetermined order in which the user must incorporate content, enter content, or specify a fax recipient to send a fax.
